(19) United States
(12) Patent Application Publication
(10) Pub. No.: US 2026/0303491 A1
(43) Pub. Date: Oct. 1, 2026

(54) SYSTEMS AND METHODS FOR IMPROVED MONITORING FEATURES FOR OF A NETWORK TOPOLOGY AND CORRESPONDING USER INTERFACES

(71) Applicant: Aviatrix Systems, Inc., Santa Clara, CA (US)

(72) Inventors: Brighton Vino Jegarajan, Santa Clara, CA (US); Arno Lenin Malyala, Santa Clara, CA (US); Joshua Wu, Santa Clara, CA (US); Shiva Sundarrajan, Santa Clara, CA (US); Henry Luo, Santa Clara, CA (US); Michael Hu, Santa Clara, CA (US); Josh Cridlebaugh, Santa Clara, CA (US); Ken Crimmins, Santa Clara, CA (US); Praveen Raju Kariyanahalli, Santa Clara, CA (US); Khanh Nguyen, Santa Clara, CA (US)

(73) Assignee: Aviatrix Systems, Inc., Santa Clara, CA (US)

(21) Appl. No.: 19/100,910

(22) PCT Filed: Aug. 3, 2023
(86) PCT No.: PCT/US2023/029447

§ 371 Date: Feb. 3, 2025

Related U.S. Application Data
(60) Provisional application No. 63/394,903, filed on Aug. 3, 2022.

(51) Int. Cl. H04L 43/045; H04L 41/22

(52) U.S. Cl. CPC H04L 43/045; H04L 41/22

(57) ABSTRACT

A distributed cloud computing system includes a controller configured to (i) deploy and manage a first gateway in a first cloud computing network and a second gateway in a second cloud computing network, and (ii) manage a plurality of constructs; and logic, stored on non-transitory, computer-readable medium, that, upon execution by one or more processors, causes performance of operations. The operations include: receiving, from each of the first gateway and the second gateway, network data, generating an expected network traffic based upon the network data, generating a visualization illustrating an anomaly that deviates from the expected network traffic, and causing rendering of the visualization on a display screen of a network device.

### CROSS REFERENCE TO RELATED APPLICATIONS

This patent application claims priority from, and incorporates by reference the entire disclosure of U.S. Provisional Application No. 63/394,903, filed on Aug. 3, 2022.

### TECHNICAL FIELD

Embodiments of the disclosure relate to the field of cloud networking. More specifically, one embodiment of the disclosure is directed to a system and method for providing operational visibility of an enterprise network.

### BACKGROUND

This section provides background information to facilitate a better understanding of the various aspects of the disclosure. It should be understood that the statements in this section of this document are to be read in this light, and not as admissions of prior art.

Until recently, businesses have relied on application software installed on one or more electronic devices residing in close proximity to its user (hereinafter, “on-premises electronic devices”). These on-premises electronic devices may correspond to an endpoint device (e.g., personal computer, cellular smartphone, netbook, etc.), a locally maintained mainframe, or even a local server for example. Depending on the size of the business, the purchase of the on-premises electronic devices and their corresponding software required a significant upfront capital outlay, along with significant ongoing operational costs to maintain the operability of these on-premises electronic devices. These operational costs may include the costs for deploying, managing, maintaining, upgrading, repairing and replacing these electronic devices.

Recently, more businesses and individuals have begun to rely on public cloud networks (hereinafter, “public cloud”) for providing users to a variety of services, from word processing application functionality to network management. A “public cloud” is a fully virtualized environment with a multi-tenant architecture that provides tenants (i.e., users) with an ability to share computing and storage resources while, at the same time, retaining data isolation within each user's cloud account. The virtualized environment includes on-demand, cloud computing platforms that are provided by a collection of physical data centers, where each data center includes numerous servers hosted by the cloud provider. Examples of different types of public cloud networks may include, but is not limited or restricted to AMAZON WEB SERVICES®, MICROSOFT® AZURE®, GOOGLE CLOUD PLATFORM™ or ORACLE CLOUD™ for example.

This growing reliance on public cloud networks is due, in large part, to a number of cost-saving advantages offered by this particular deployment. However, for many types of services, such as network management for example, network administrators face a number of challenges when business operations rely on operability of a single public cloud or operability of multiple public cloud networks. For instance, where the network deployed by an enterprise relies on multiple public cloud networks (hereinafter, “multi-cloud network”), network administrators have been unable to effectively troubleshoot connectivity issues that occur within the multi-cloud network. One reason for such ineffective troubleshooting is there are no conventional solutions available to administrators or users to visualize connectivity of its multi-cloud network deployment. Another reason is that cloud network providers permit the user with access to only a limited number of constructs, thereby controlling the type and amount of network information accessible by the user. As a result, the type or amount of network information is rarely sufficient to enable an administrator or user to quickly and effectively troubleshoot and correct network connectivity issues.

Likewise, there are no conventional solutions to visually monitor the exchange of traffic between network devices in different public cloud networks (multi-cloud network) and retain state information associated with network devices with the multi-cloud network to more quickly detect operational abnormalities that may suggest a cyberattack is in process or the health of the multi-cloud network is compromised. Further, what is needed is a system and methods of implementing the same that generate a graphical user interface that enable an administrator or other user to build a network topology graph in an intuitive manner where the system then automatically deploys constructs and applicable communication lines between such constructs thereby generating a fully operational network topology. Even further, what is needed is a graphical user interface that displays a network topology graph in a visually scalable manner, i.e., the visual display of icons representing constructs, edges, and other aspects of a network topology graph automatically adjusts to reduce visual clutter and provide for ease of viewing. Such systems, methods, and resultant graphical user interfaces should also provide for various monitoring, searching, and filtering capabilities directly from the graphical user interfaces.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

A distributed cloud computing system includes a controller configured to (i) deploy and manage a first gateway in a first cloud computing network and a second gateway in a second cloud computing network, and (ii) manage a plurality of constructs; and logic, stored on non-transitory, computer-readable medium, that, upon execution by one or more processors, causes performance of operations. The operations include: receiving, from each of the first gateway and the second gateway, network data, generating an expected network traffic based upon the network data, generating a visualization illustrating an anomaly that deviates from the expected network traffic, and causing rendering of the visualization on a display screen of a network device.

A non-transitory computer-readable medium having stored thereon logic that, when executed by one or more processors, causes operations including: receiving, from a controller, network data from a first gateway and a second gateway, generating an expected network traffic based upon the network data, generating a visualization illustrating an anomaly that deviates from the expected network traffic, and causing rendering of the visualization on a display screen of a network device.

A computerized method includes receiving, from a controller, network data from a first gateway and a second gateway, generating an expected network traffic based upon the network data, generating a visualization illustrating an anomaly that deviates from the expected network traffic, and causing rendering of the visualization on a display screen of a network device.

In some aspects, the visualization comprises a graph displaying actual network traffic overlayed on top of the expected network traffic. In some aspects, the expected network traffic is divided into a plurality of thresholds of expected network traffic. In some aspects, the plurality of thresholds includes: a first threshold that illustrates a tolerance range of the expected network traffic; and a second threshold that illustrates values of network traffic that exceed the first threshold. In some aspects, when the network traffic is within the first threshold, the visualization does not include a visual indication of the anomaly and, when the network traffic exceeds the second threshold, the visualization comprises a visual indication of the anomaly.

In some aspects, the visualization comprises a secondary graph displaying parameters describing the network data. In some aspects, the parameters describing network data are one or more of TCP ports and IP addresses.

In some aspects, the visualization includes a user input that allows a user to characterize the anomaly as not an anomaly. In some aspects, responsive to an indication that the anomaly is not an anomaly, the data associated with the anomaly is used as part of the network data upon which the expected network traffic is generated.

In some aspects, the visualization includes a graph of disk usage and projected disk runway. In some aspects, the visualization includes a user input configured to select an amount of time for which data is to be backed up. In some aspects, the graph of disk usage dynamically changes in response to manipulations of the user input.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 is a diagram of an exemplary embodiment of a distributed cloud computing system including a controller managing constructs spanning multiple cloud networks according to some embodiments;

FIG. 2A is an exemplary illustration of a logical representation of a controller deployed within a cloud computing platform in accordance with some embodiments;

FIG. 2B, an exemplary illustration of a logical representation of the topology system logic deployed within a cloud computing platform in accordance with some embodiments;

FIG. 3A-3B illustrate interface screens displaying portions of a dashboard of a visualization platform directed to illustrating information pertaining to anomalies within a cloud-computing environment according to some embodiments;

FIGS. 4A-4E are interface screens displaying portions of a dashboard of a visualization platform directed to illustrating information pertaining to network traffic within a cloud-computing environment according to some embodiments; and FIGS. 5A-5C are interface screens displaying portions of a dashboard of a visualization platform directed to illustrating information pertaining to disk usage within a cloud-computing environment according to some embodiments.

### DETAILED DESCRIPTION

Embodiments of the disclosure are directed to a system configured to provide operational visibility of a network that spans one or more cloud computing environments. According to one embodiment, the system may include a software instance that is operating in one or more cloud computing resources and is configured to collect information and render a graphic user interface (GUI) that provides an interactive, visual rendering of the connectively between constructs of a network spanning multiple (two or more) cloud computing environments (hereinafter, a “multi-cloud computing environment or a “multi-cloud network”). In other embodiments, the system includes the software instance and a controller configured to manage constructs deployed in one or more cloud computing environments such as within a multi-cloud environment and communicate with the software instance.

As will be discussed below in further detail, the software instance may query the controller for information using one or more Application Programming Interface (API) calls to retrieve information stored by the controller detailing status information of each construct managed by the controller. The controller obtains such information from one or more gateways deployed within a multi-cloud network, where the gateway(s) are configured to transmit this information to the controller on a periodic (or aperiodic) basis. It should be understood that, as discussed herein, the term “multi-cloud networks” refers a plurality of cloud networks, where each cloud network may constitute a public cloud network provided by a different cloud computing environment resource provider (hereinafter, “cloud provider”).

As is known in the art, a controller may be configured to program each gateway to control routing of network traffic such as by providing instructions to gateways as to how network traffic is routed among various gateways. As illustrative examples, the controller may instruct a gateway as to whether a virtual machine (VM) from one subnet work (hereinafter, “subnet”) may communicate directly with a VM from another subnet, or how network traffic will flow from a source to a destination within the cloud computing environment managed by the controller. In addition, embodiments of the disclosure discuss instructions provided by the software instance to the controller, which are then transmitted to one or more gateways by the controller and include instructions to transmit network data from the gateway to a routable address (e.g., an Internet Protocol “IP” address, etc.) of the software instance.

Therefore, as a general embodiment, the software instance may query the controller for data indicating a status and metadata of each construct managed by the controller and also receive network data from one or more gateways. The software instance includes logic that, upon execution by one or more processors (e.g., being part of the cloud computing resources), generates various visualizations that are a combination of the construct status and metadata (collectively “construct metadata”) and the network data. The visualizations may be interactive and provided to users such as network administrators, information technology (IT) professionals, or the like. Additionally, the visualizations may be configured to receive user input, which causes the logic of the software instance (“topology system logic”) to alter the visualizations. As discussed below and illustrated in the accompanying drawings, the visualizations may include, but are not limited or restricted to, a dashboard view providing overall status and health of the network as well as specific network parameters; a dynamic topology mapping that provides a visual rendering of each construct and links that identify communications between the constructs; and a network flow visualization providing various illustrations detailing how network traffic is flowing (or has flowed) through the cloud computing environment managed by the controller. Each of the visualizations may provide data spanning a multi-cloud network.

In some embodiments, responsive to the user input, the topology system logic may generate tags for one or more of the constructs via the topology mapping visualization and store those tags for searching. For example, further user input may be received causing the topology system logic to search the numerous constructs managed by the controller and display the tagged constructs, as well as any links therebetween, via the topology mapping. In yet some embodiments, responsive to received user input including one or more tags as search items, the topology system logic may generate visualizations illustrating the network flow of the corresponding tagged construct(s).

By querying the controller for construct metadata and receiving network data from one or more gateways, the topology system logic may generate the exemplary visualizations described above, and those shown in the accompanying drawings, that illustrate the flow of network traffic associated with one or more tagged constructs. As is noted throughout, the illustrated flow of network traffic may correspond to constructs deployed in multiple cloud networks. Such operability provides numerous advantages to users over the current art by enabling users to tag one or more gateways residing in different public cloud networks with meaningful tags and search for construct parameters, construct status, link status and the flow of network traffic corresponding to that tag.

An additional functionality of the topology system logic is the generation of visualizations that illustrate changes to aspects of the network managed by the controller over time. For example and as discussed below, the topology system logic may store the received data pertaining to the network (the network data and the construct metadata) for given points in time, e.g., t₁→tᵢ (where i>1). Upon receiving user input corresponding to a request to display the changes between two points in time, e.g., t₁ and t₂, the topology system logic compares the stored data for t₁ and t₂, and generate a visual that highlights the change(s) between the network at t₁ and t₂. The term “highlight” may refer to any visual indicator or combination of visual indicators, such as color-coding constructs having changed parameters, varying the size of constructs having changed parameters, displaying a graphic (e.g., a ring) around constructs having changed parameters, displaying a window or other image that lists the detected changes in state of the network, which may spanning multiple public cloud networks, between time t₁ and time t₂, or other types of visual indicators.

### Terminology

In the following description, certain terminology is used to describe features of the invention. In certain situations, the term “logic” is representative of hardware, firmware, and/or software that is configured to perform one or more functions. As hardware, the logic may include circuitry having data processing or storage functionality. Examples of such circuitry may include, but are not limited or restricted to a microprocessor, one or more processor cores, a programmable gate array, a microcontroller, an application specific integrated circuit, wireless receiver, transmitter and/or transceiver circuitry, semiconductor memory, or combinatorial logic.

Alternatively, or in combination with the hardware circuitry described above, the logic may be software in the form of one or more software modules. The software module(s) may include an executable application, an application programming interface (API), a subroutine, a function, a procedure, an applet, a servlet, a routine, source code, a shared library/dynamic load library, or one or more instructions. The software module(s) may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the executable code may be stored in persistent storage.

The term “computerized” generally represents that any corresponding operations are conducted by hardware in combination with software and/or firmware.

The term “construct” may be construed as a virtual or physical logic directed to a particular functionality such as a gateway, virtual private cloud network (VPC), sub-network, or the like. For instance, as an illustrative example, the construct may correspond to virtual logic in the form of software (e.g., a virtual machine), which may assign a device-specific address (e.g., a Media Access Control “MAC” address) and/or an IP address within an IP address range supported by to a particular IP subnet. Alternatively, in some embodiments, the construct may correspond to physical logic, such as an electronic device that is communicatively coupled to the network and assigned the MAC and/or IP address(es). Examples of electronic devices may include, but are not limited or restricted to a personal computer (e.g., desktop, laptop, tablet or netbook), a mobile phone, a standalone appliance, a sensor, a server, or an information routing device (e.g., a router, bridge router (“brouter”), etc.). It is contemplated that each construct may constitute at least logic residing as part of a public network, although certain constructs may be deployed as part of an “on-premises” (or local) network.

The term “gateway” may refer to a software instance deployed within a public cloud network or a virtual private cloud network deployed with the public cloud network and controls the flow of data traffic within and from the public cloud network (e.g., to one or more remote sites including computing devices that may process, store and/or continue the routing of data). Herein, each gateway may operate as a “transit gateway” or “spoke gateway,” which are gateways having similar architectures but are identified differently based on their location/configurations within a cloud computing environment. For instance, a “spoke” gateway is configured to interact with targeted instances while a “hub” gateway is configured to further assist in the propagation of data traffic (e.g., one or more messages) directed to a spoke gateway or a computing device within an on-premises network.

The term “network traffic metrics” may refer to measurements of network traffic transmission including amount, frequency and/or latency. In some embodiments, network traffic metrics may include identification of a source and/or destination (e.g., IP address, originating/destination gateway, originating/destination VPC, originating/destination geographic region, etc.). Further, in some embodiments, network traffic metrics may also refer to analyses performed on and/or filtering of measurements of network traffic transmission.

The term “controller” may refer to a software instance deployed within a cloud computing environment (e.g., resources of a public cloud network) that manages operability of certain aspects of one or more cloud computing environments spanning across different public cloud networks (multi-cloud network). For instance, a controller may be configured to collect information pertaining to each VPC and/or each gateway instance and configures one or more routing tables associated with one or more VPCs and/or gateway instances spanning a multi-cloud network to establish communication links (e.g., logical connections) between different sources and destinations. These sources and/or destinations may include, but are not restricted or limited to on-premises computing devices, gateway instances or other types of cloud resources.

The term “message” generally refers to information in a prescribed format and transmitted in accordance with a suitable delivery protocol. Hence, each message may be in the form of one or more packets, frames, or any other series of bits having the prescribed format.

The term “link” may be generally construed as a physical or logical communication path between two or more constructs. For instance, as a physical communication path, wired and/or wireless interconnects in the form of electrical wiring, optical fiber, cable, bus trace, or wireless channel using infrared, radio frequency (RF), may be used. A logical communication path includes any communication scheme that enables information to be exchanged between multiple constructs.

Finally, the terms “or” and “and/or” as used herein are to be interpreted as inclusive or meaning any one or any combination. As an example, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure is to be considered as an example of the principles of the invention and not intended to limit the invention to the specific embodiments shown and described

### General Architecture—Topology System

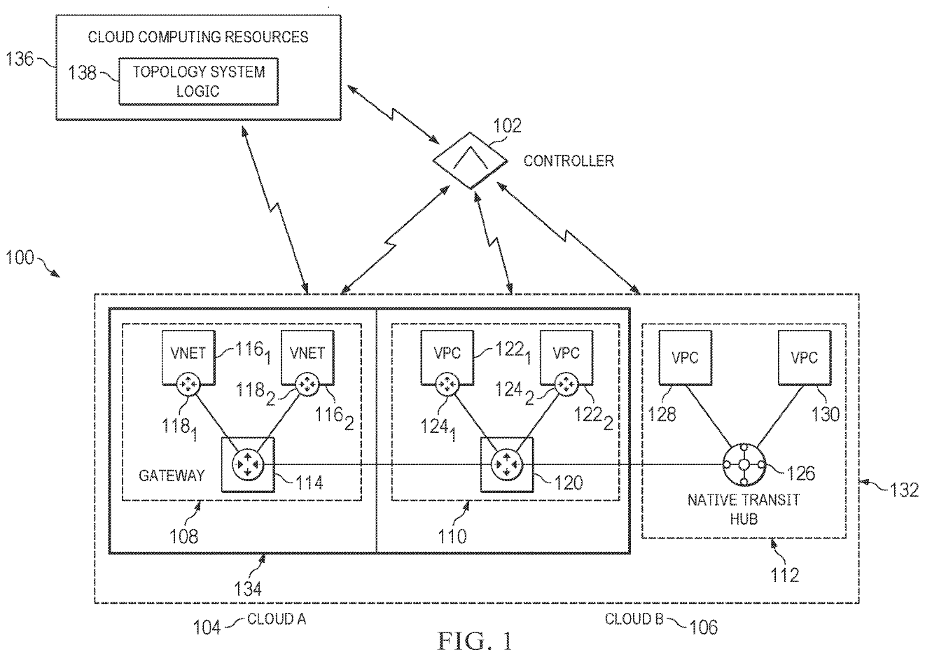

Referring to FIG. 1, a diagram of an exemplary embodiment of a distributed cloud management system 100 is shown, where the cloud computing system features a controller 102 for managing constructs residing in multiple cloud networks and a software instance 138 to visualize the managed constructs (hereinafter, “topology system logic”). More specifically, the controller 102 is configured to manage multiple constructs spanning multiple cloud networks, such as cloud (network) A 104 and cloud (network) B 106. In the exemplary illustration, cloud A 104 provides computing resources (“resources”) for a transit gateway 114 in communication with gateways 118₁-118₂ associated with virtual networks (VNETs) 116₁-116₂. Cloud B 106 provides resources for a transit gateway 120 in communication with gateways 124₁-124₂ associated with virtual private clouds (VPCs) 122₁-122₂. Cloud B 106 further provides resources for a native transit hub 126 in communication with VPCs 128 and 130. According to this embodiment of the disclosure, as shown in FIG. 1, the transit gateways 114, 120 and the native transit hub 126 are in communication with each other. Thus, as should be clearly understood that the controller 102 is managing several constructs, such as the illustrated gateways, that span multiple cloud networks.

Specifically, a first grouping of constructs 108 is deployed within the Cloud A 104, and second and third groupings of constructs 110, 112 are deployed within Cloud B 106. The controller 102 utilizes a set of APIs to provide instructions to and receive data (status information) associated with each of these constructs as well as status information pertaining to each connection between these constructs (link state). The construct metadata returned by a construct may depend on the type of construct (e.g., regions, VPCs, gateway, subnets, instances within the VPCs, etc.), where examples of construct metadata may include, but is not limited or restricted to one or more of the following construct parameters (properties): construct name, construct identifier, encryption enabled, properties of the VPC associated with that construct (e.g. VPC name, identifier and/or region, etc.), cloud properties in which the construct is deployed (e.g., cloud vendor in which the construct resides, cloud type, etc.), or the like.

Additionally, the cloud management system 100 includes topology system logic 138 processing on cloud computing resources 136. In some embodiments, the topology system logic 138 may be logic hosted on a user's Infrastructure as a Service (IaaS) cloud or multi-cloud environment. As one example, the topology system logic 138 may be launched as an instance within the public cloud networks (e.g., as an EC2® instance in AWS®). As an alternative example, the topology system logic 138 may be launched as an virtual machine in AZURE®. When launched, the topology system logic 138 is assigned a routable address such as a static IP address for example.

As shown, the topology system logic 138 is in communication with the controller 102 via, for example, an API that enables the topology system logic 138 to transmit queries to the controller 102 via one or more API calls. The topology system logic 138, upon execution by the cloud computing resources 136, performs operations including querying the controller 102 via API calls for construct metadata in response to a particular event. The particular event may be in accordance with a periodic interval or an aperiodic interval or a triggering events such as a user request for a visualization via user input.

In some embodiments, in response to receiving a query via an API call from the topology system logic 138, the controller 102 accesses data stored on or by the controller 102 and returns the requested data via the API to the topology system logic 138. For example, the topology system logic 138 may initiate one or more queries to the controller 102 to obtain topology information associated with the constructs managed by the controller 102 (e.g., a list of all gateways managed by the controller 102, a list of all VPCs or VNETs managed by the controller 102, or other data gathered from database tables) along with status information associated with each construct as described above.

Upon receiving the requested construct metadata, the topology system logic 138 performs one or more analyses and determines whether any additional construct metadata needs to be requested. For example, the topology system logic 138 may provide a first query to the controller 102 requesting a list of all gateways managed by the controller 102. In response to receiving the requested construct metadata, the topology system logic 102 determines the interconnections between the gateways listed. Subsequently, the topology system logic 138 may provide a second query to the controller 102 requesting a list of all VPCs managed by the controller. In response to receiving the requested construct metadata, the topology system logic 138 determines the associations between each VPC and a corresponding gateway.

For example, in some embodiments, the received construct metadata provides detailed information for each gateway enabling the topology system logic 138 to generate a data object, e.g., a database table of the construct metadata, that represents a gateway. The data object representing the multiple gateways are cross-referenced to build out a topology mapping based on the parameters of each gateway, which may include, inter alia: cloud network user account name; cloud provider name; VPC name; gateway name; VPC region; sandbox IP address; gateway subnet identifier; gateway subnet CIDR; gateway zone; name of associated cloud computing account; VPC identifier; VPC state; parent VPC name; VPC CIDR; etc. Similarly, the construct metadata is also utilized to generate a data object representing each VPC object and each subnet object.

Additionally, in order to determine whether a connection within the network is between two transit gateways, a separate API call may be utilized by the topology system logic 138 to query the controller 102 for a listing of all transit gateways. Thus, the topology system logic 138 is then able to determine whether a connection between a first gateway and a second gateway is between two transit gateways. In some embodiments, as will be discussed below, the connections between transit gateways and the connections between a spoke gateway and a transit may be represented visually in two distinct methods.

In addition to receiving the construct metadata from the controller 102, the topology system logic 138 may also receive network data from one or more gateways managed by the controller 102. For example, the network data may include for each network packet, but is not limited or restricted to, an ingress interface, a source IP address, a destination IP address, an IP protocol, a source port for UDP or TCP, a destination port for UDP or TCP, a type and code for ICMP, an IP “Type of Service,” etc. In one embodiment, the network data may be transmitted to the topology system logic 138 from a gateway using an IP protocol, for example, UDP. In some embodiments, the network data is collected and exported via the NetFlow network protocol.

In order to configure a gateway to transmit the network data to the topology system logic 138, the topology system logic 138 may provide instructions to the controller 102, which in turn provides the instructions to each gateway managed by the controller 102. The instructions provide the IP address of the topology system logic 138, which is used as the IP address for addressing the transmission of the network data.

As will be discussed in detail below, the topology system logic 138 may generate a visualization platform comprising one or more interactive display screens. These display screens may include a dashboard, a topology mapping and a network flow visualization. Additionally, the visualization platform may be configured to receive user input that causes filtering of the of the displayed data.

For example and still with reference to FIG. 1, the topology system logic 138 may generate a topology mapping visualization of the connections linking the constructs detected the controller 102, which are illustrated by the constructs within a logical region 132 represented by Cloud A 104 and Cloud B 106. Additionally, the topology system logic 138 may generate various graphical user interfaces (GUIs) that illustrates network traffic flows, traffic flow heat maps, packet capture, network health, link latency, encryption, firewalls, etc., network traffic flowing between, to and from constructs managed by the controller 102 as illustrated by a second logical region 134.

Embodiments of the disclosure offer numerous advantages over current systems that provide a dashboard illustrating parameters of a controller as current systems do not provide the ability to visualize connections between constructs deployed across multiple cloud networks, the state of resources and connections between resources for multiple clouds and the flow of network data through constructs spanning multiple clouds. As one example, an enterprise network may utilize resources deployed in a plurality of cloud networks and an administrator of the enterprise network may desire to obtain visualization of the status of all constructs and connections associated with these resources. However, because the enterprise network spans multiple cloud networks, conventional systems fail to provide such a solution. By merely obtaining a textual representation of a status of each construct within a single cloud (e.g., through a command line interface), an administrator is unable to obtain a full view of the constructs, connections therebetween and the status of each for the entire enterprise network. Further, detection of anomalous or malicious network traffic patterns may not be detectable in the manner provided by current systems.

As used herein, a visualization (or visual display) of the constructs, connections therebetween and the status of each is referred to as a topology mapping. Current systems fail to provide a topology mapping across multiple cloud networks and fail to allow an administrator to search across multiple cloud networks or visualize how changes in a state of a construct or connection in a first cloud network affects the state of a resource or connection in a second cloud network. In some embodiments, the topology mapping may automatically change as a state of a construct or connection changes or upon receipt of construct metadata updates in response to certain events such as at periodic time intervals (e.g., a “dynamic topology mapping”).

In some embodiments, a network may be deployed across multiple cloud networks using a plurality of controllers to manage operability of the network. In some such embodiments, each controller may gather the information from the network and constructs which it manages and a single controller may obtain all such information, thereby enabling the visualization platform to provide visibility across a network (or networks) spanning multiple controllers.

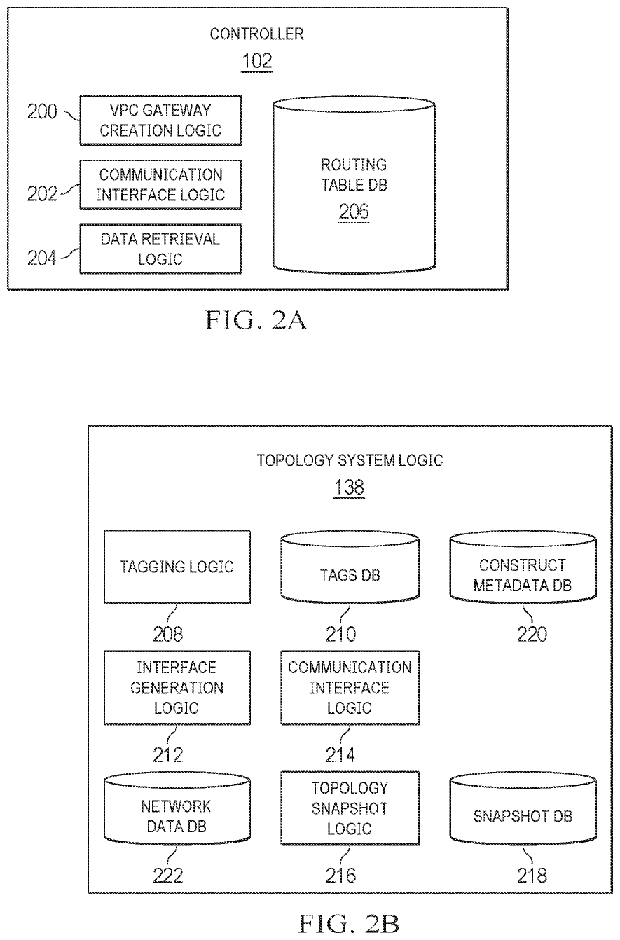

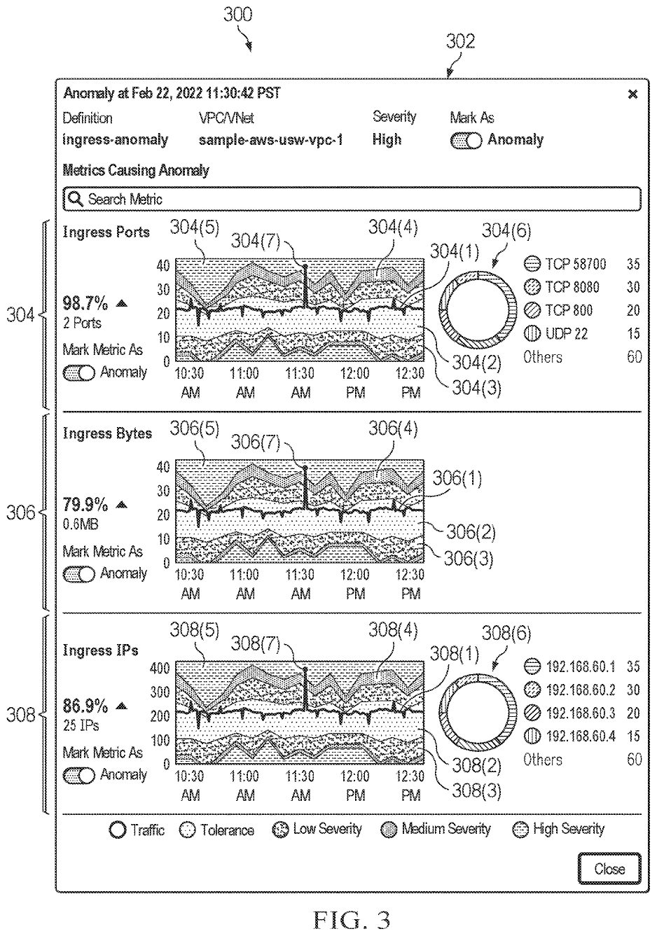

Referring to FIG. 2A, an exemplary illustration of a logical representation of the controller 102 deployed within the cloud management system 100 is shown in accordance with some embodiments. The controller 102, as noted above, may be a software instance deployed within the cloud network to assist in managing operability of constructs within multiple public cloud networks. According to this embodiment, the controller 102 may be configured with certain logic modules, including, a VPC gateway creation logic 200, a communication interface logic 202 and a data retrieval logic 204. The controller 102 may also include a routing table database 206.

In some embodiments, the gateway creation logic 200 performs operations to create a gateway within a VPC including creating a virtual machine within a VPC, provide configuration data to the virtual machine, and prompt initialization of the gateway based on the configuration data. In one embodiment in which the cloud computing resources utilized are AWS®, the VPC gateway creation logic 200 launches a virtual machine within a VPC, the virtual machine being an AMAZON® EC2 instance. The virtual machine is launched using a pre-configured virtual machine image published by the controller 102. In the particular embodiment, the virtual machine image is an Amazon Machine Image (AMI). When launched, the virtual machine is capable of receiving and interpreting instructions from the controller 102.

The communication interface logic 202 may be configured to communicate with the topology system logic 138 via an API. The controller 102 may receive queries from the topology system logic 138 via one or more API calls and respond with requested data via the API.

The data retrieval logic 204 may be configured to access each construct managed by the controller 102 and obtain construct metadata therefrom. Alternatively, or in addition, the data retrieval logic 204 may receive such construct metadata that is transmitted (or “pushed”) from the constructs without the controller 102 initiating one or more queries (e.g., API calls).

The routing table database 206 may store VPC routing table data. For example, the controller 102 may configure a VPC routing table associated with each VPC to establish communication links (e.g., logical connections) between a transit gateway and cloud instances associated with a particular instance subnet. A VPC routing table is programmed to support communication links between different sources and destinations, such as an on-premise computing devices, a cloud instance within a particular instance subnet or the like. Thus, the controller 102 obtains and stores information that reveals certain properties of resources (e.g., constructs such as gateways, subnets, VPCs, instances within VPCs, etc.) within the purview of the controller 102 as well as status information pertaining to the connections (communication links) between with these resources.

Referring to FIG. 2B, an exemplary illustration of a logical representation of the topology system logic 138 deployed within a cloud computing platform is shown in accordance with some embodiments. The topology system logic 138 may be a software instance deployed using the cloud computing resources 136 and is configured to communicate with the controller 102 and each of the gateways managed by the controller 102. The topology system logic 138 is configured with certain logic modules, including, a tagging logic 208, a tags database 210, an interface generation logic 212, a communication interface logic 214, a topology snapshot logic 216. Additionally, the topology system logic 138 may include a snapshot database 218, a construct metadata database 220 and a network data database 222.

### Exemplary User Interfaces—Topology System Visualization Platform

The exemplary user interfaces illustrated in FIGS. 3-5 may be configured by the topology system logic 138 to be rendered and displayed on various display screens and via various applications. For example, each of the user interfaces illustrated in FIGS. 3-5 may be configured to be displayed through a web browser on a computer display screen, a laptop, a mobile device, or any other network device that includes a web browser. Additionally, each of the user interfaces illustrated in FIGS. 3-5 may be configured to be displayed through a dedicated software application installed and configured to be executed on any of the network devices described above. For example, the topology system logic 138 may be configured to provide the data and user interfaces described herein to a software application (known in the art as an “app”) that may be installed and configured to be executed by one or more processors of a network device. Thus, upon execution, the app causes the user interfaces described herein to be rendered on the display screen of the network device (or an associated display screen).

Referring now to FIG. 3, a graphical user interface (GUI) screen (or “interface screen”) displaying portions of a dashboard topology system visualization platform (“visualization platform”) with each portion configured to illustrate information obtained or determined by the topology system is shown according to aspects of the disclosure. The interface screen of FIG. 3 may be referred to as a dashboard 300 that includes several display portions that illustrate various attributes pertaining to a network that is deployed across one or more cloud providers, and notably across multiple cloud providers.

Dashboard 300 is configured to display various anomaly reporting graphs 304-308. Dashboard 300 includes a header 302 that provides information regarding a reported anomaly. For example, header 302 may include a definition (i.e., what type of anomaly is being tracked), an identification of the VPC/Vnet associated with the anomaly, a classification of the severity of the anomaly, and user input or toggle that a user may use to classify the event as an anomaly or not. It will be appreciated that the toggle could be any type of user input (e.g., a radio button, drop down, text field, etc.) by which the user may verify the anomaly. For example, a user may review dashboard 300 and determine that the event is not an anomaly (e.g., the reported increased traffic is expected). In some aspects, classifying the event as not an anomaly allows the system to use the data associated with the event as a learned data point regarding traffic behavior for future reference. Header 302 may further include a search bar that allows a user to search for specific metric types (e.g., per country traffic, per protocol traffic, egress ports, egress countries, egress IPs, egress bytes, egress packets, ingress ports, ingress countries, ingress IPs, ingress bytes, ingress packets, total bytes, and total packets).

Graphs 304-308 provide anomaly details that provide context (e.g., when, how, and what) regarding the identified anomaly. Graphs 304-308 provide visual information to a user so that the anomaly may be quickly analyzed, and any necessary mitigation steps can be taken. For each graph 304-308, the x-axis tracks time. As illustrated in FIG. 3, the x-axis is configured to show approximately one hour of data prior to the occurrence of the anomaly and approximately one hour of data after the occurrence of the anomaly to provide context regarding how the system was performing around the time of the anomaly. In other aspects, the amount of time prior to and after the anomaly may be varied. For each of graphs 304-308, the y-axis may be configured as one of various parameters, such as ingress ports (304), ingress bytes (306), ingress IPs (308). The Y-axis unit represents the scale for the values of the metric. For example, if the graph is for ingress IPs and if the values of the IPs are 1, 3, 5, 8 etc. during the timestamps in x-axis, then the scale of the Y-axis could be 0-10. It will be appreciated that the y-axis could be configured to track other parameters. Each graph 304-308 includes a score or rating of the anomaly (e.g., graph 304 indicates a 98.7% score for the anomaly, indicating the magnitude of the increase in ingress ports versus an expected value based on learned data). In some aspects, the score may be an average of historical data. In some aspects, the score is computed using a z-score algorithm. For example, the z-score of the current data point is computed with respect to the datapoints collected during a learning period. Fingerprinted data (learning period data) is taken into account for the same time interval on the same VPC to eliminate deviations in traffic during other time intervals. Once the z-score of the current timestamp's datapoint is determined, it is compared with the user set threshold for the z-score (for the user this is termed as detection sensitivity). If the current z-score is 50% more than the user set threshold, then the current data point is an anomaly in the green zone. If it's 50-75% more then it's in the yellow zone. If it's >75%, then it is in the red zone.

Referring to graph 304, a line 304(1) that represents actual traffic is overlayed on top of learned values relating to ingress ports. Line 304(1) includes an anomaly 304(7) that is visually indicated by a dot. In various aspects, anomaly 304(7) may be visually represented as any visual feature to draw attention to the anomaly on graph 304. For example, anomaly 304(7) may be identified by a dot, a box, a triangle, a graphic or icon, text (e.g., that provides information regarding the anomaly), and the like. The learned values are expected values based upon aggregated historical data. For example, learned values may contain historical usage data for the previous 30 days. Based upon the historical usage data, an expected amount of traffic throughout the day can be estimated (e.g., an average amount of traffic). The expected amount of traffic includes an upper limit and a lower limit, and the expected value varies based on time of day. For example, graph 304 illustrates that usage is generally higher around 11:00 AM vs 10:30 AM. Anomalies may be detected by comparing measured traffic to expected traffic. When traffic deviates from the expected value, the system may flag the event as an anomaly. In some aspects, events are only flagged as anomalies if they exceed certain thresholds. Graph 304 provides a visual indication of several threshold values, each of which may be presented in a different color or shading to visually separate each threshold region. A first region 304(2) represents a tolerance range based on the learning (i.e., an acceptable or expected amount of deviation). By way of example, first region 304(2) may represent values that deviate less than 50% from the expected value based upon the learned values. Values with first region 304(2) fall within the range of what is considered expected or normal and are not flagged as anomalies. Regions 304(3)-304(5) represent a first threshold of deviation (e.g., 50-75%), a second threshold of deviation (e.g., 75-90%), and a third threshold of deviation (e.g., >90%), respectively. These deviation percentages are illustrative, and may be changed. Depending on the configuration of the system, an anomaly may be reported when the value exceeds any of the thresholds of regions 304(3)-304(5). In this way, some parameters may be set to be flagged as anomalies when the deviation value reaches region 304(3) (i.e., parameters for which even lower amounts of deviation are unacceptable). For other parameters, it may be acceptable for greater amounts of deviation, in which case an anomaly is only flagged when the deviation value reaches region 304(5).

Graph 304 includes a secondary graph 304(6) (e.g., a donut chart) that provides additional information that may be helpful in analyzing the reported anomaly. Secondary graph 304(6) identifies the type and number of ports in use at the time of the anomaly.

Graphs 306 and 308 include similar features and are numbered accordingly. Graph 306 provides information regarding ingress bytes and graph 308 provides information regarding ingress IPs. In various aspects, additional graphs may be displayed for other parameters. Providing multiple parameters provides more context to the user regarding the system at the time of the anomaly.

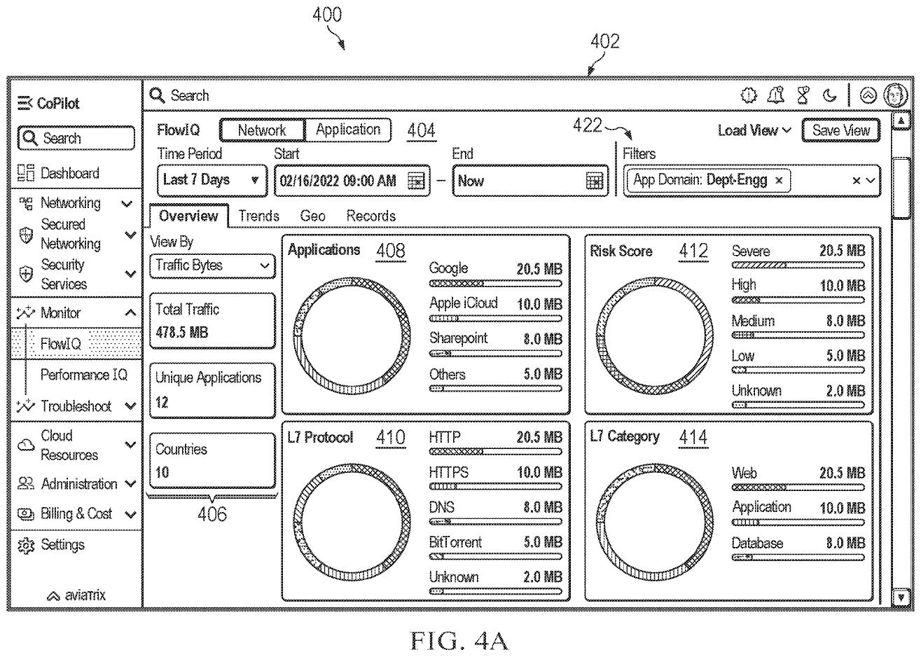

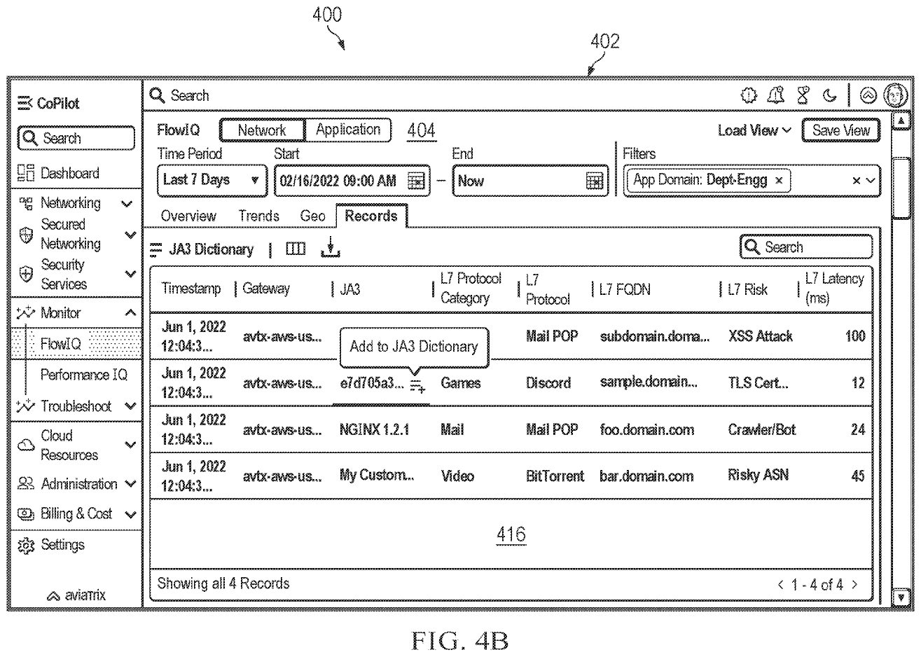

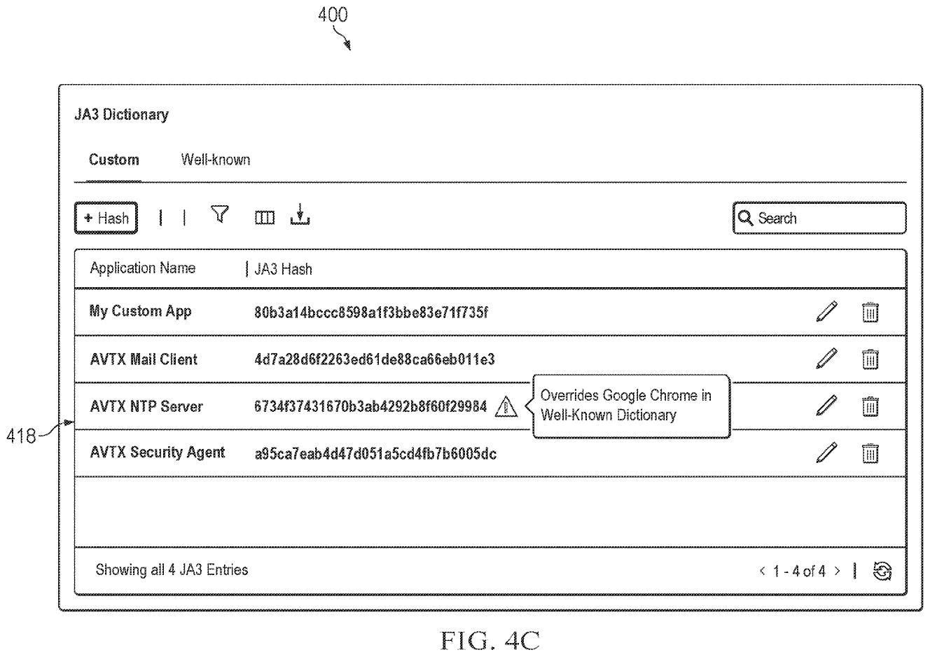

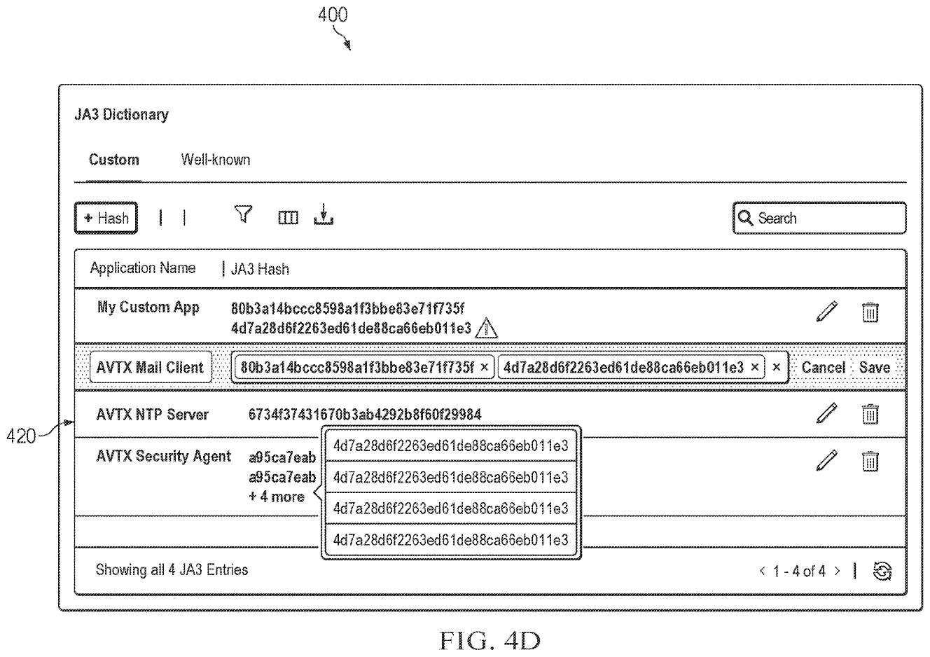

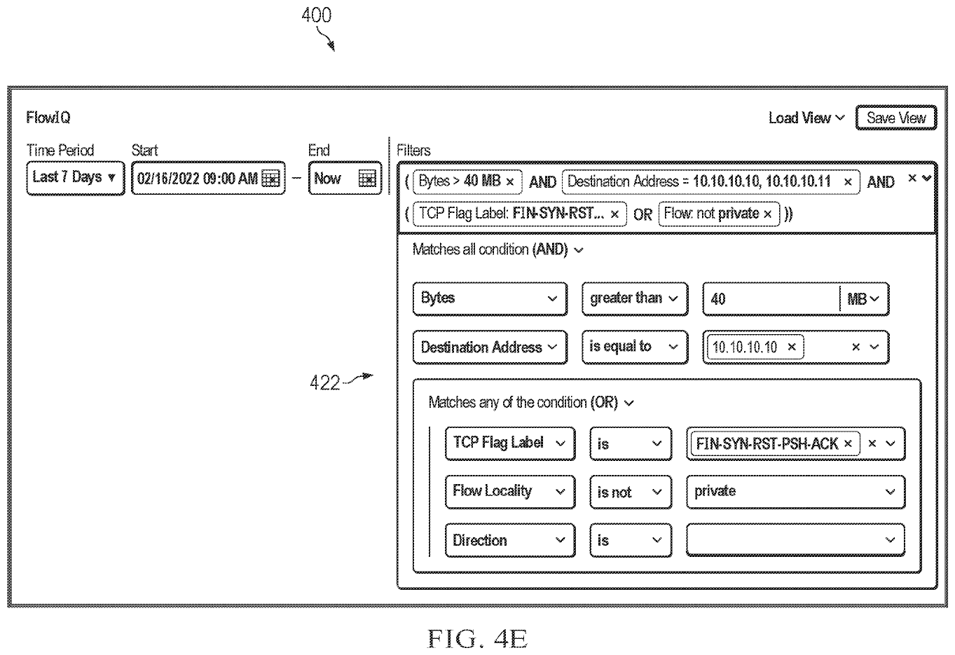

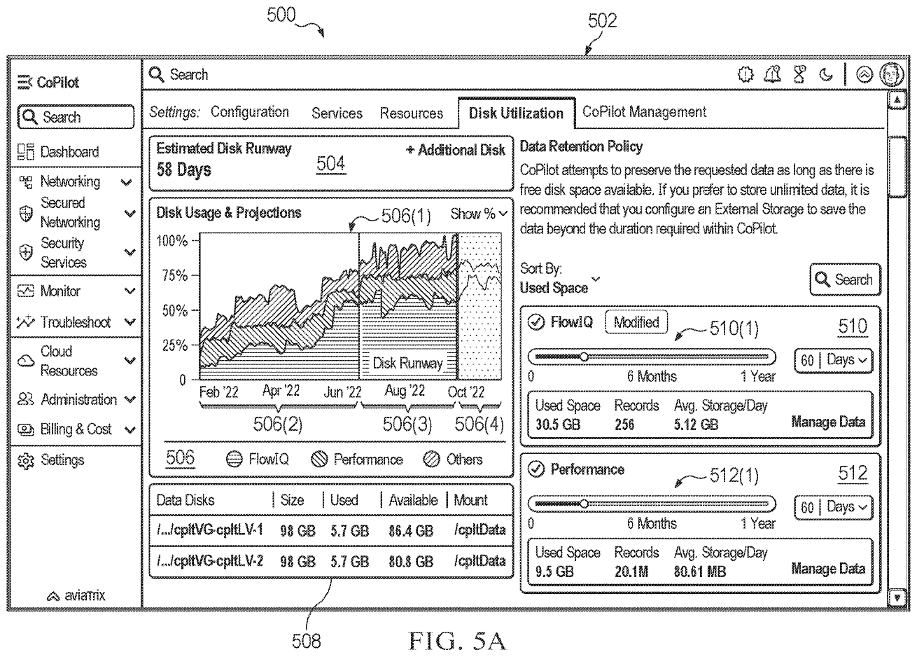

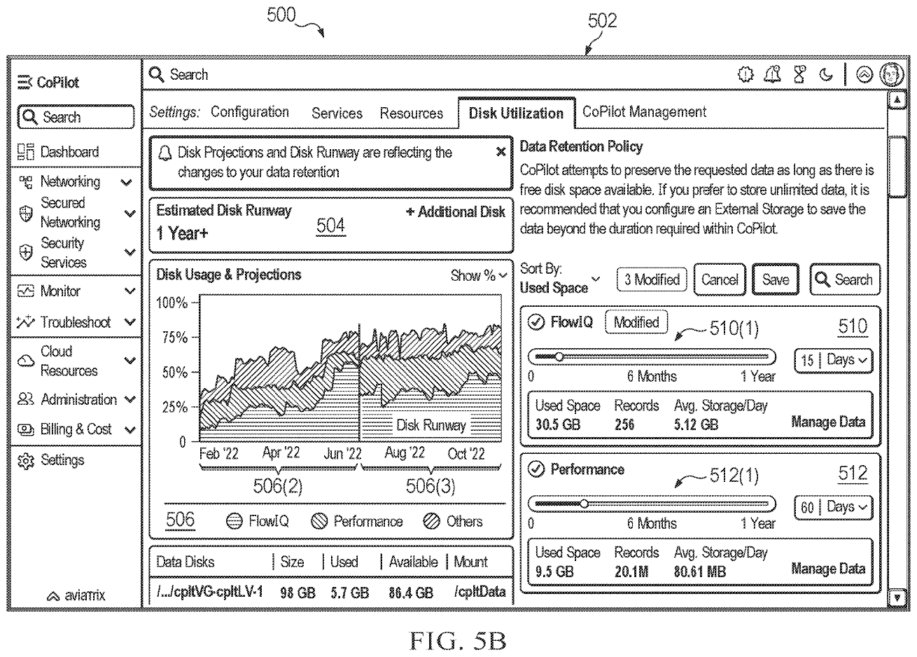

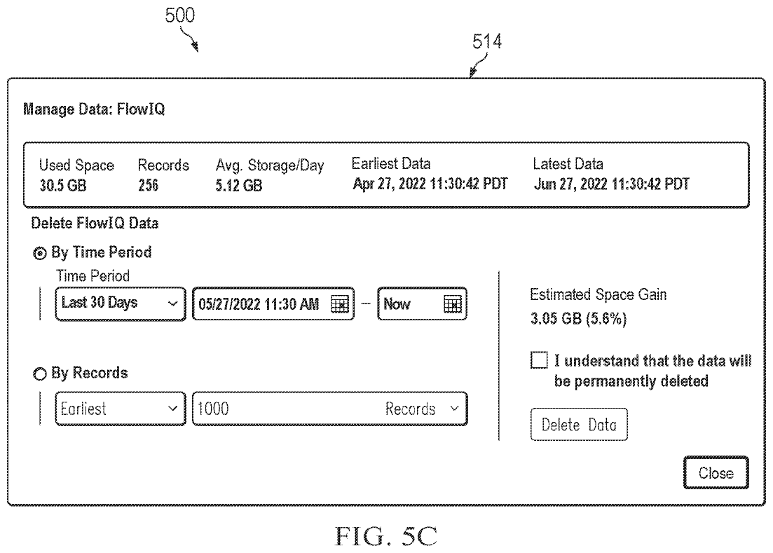

FIGS. 4A-4E illustrate GUI screens displaying portions of a dashboard topology system visualization platform, with each portion configured to illustrate information obtained or determined by the topology system. The interface screens of FIGS. 4A-4E may be referred to as a dashboard 400 that includes several display portions that illustrate various attributes pertaining to a network that is deployed across one or more cloud providers, and notably across multiple cloud providers.

Dashboard 400 is configured to display various parameters that describe a status or health of the underlying topology. Referring to FIG. 4A, dashboard 400 illustrates a menu 402, a header 404, a summary section 406, and graphs 408-414. Menu 402 enables a user to easily navigate to different options provided by the topology system visualization platform. Menu 402 can comprise various buttons, drop downs, and the like to assist with navigation through the topology system visualization platform.

Header section 404 allows a user of the topology system visualization platform to make various selections via drop downs and/or search fields. As illustrated in FIG. 4A, header section 404 allows the user to specify a time period (e.g., last 7 days), a start date/time, an end date/time, and a filter 422 to limit/target the monitored data. FIG. 4E illustrates an exemplary filter 422 that may be used to create structured searches. Header section 404 also allows the user to select between different tabs to view different information, such as an overview (i.e., illustrated in FIG. 4A), trends, geo, and records (see FIG. 4B-4D). The trends page shows time series line charts for traffic by top applications, another time series chart for traffic by risk score. FIG. 4B represents raw netflow records forwards by gateways to the topology system visualization platform. The records contain identifying information about the application that has sent/received the traffic and the protocol it used to forward the traffic. Based on the type of the application, a risk score is computed and the usual vulnerabilities for such application traffic are listed. FIG. 4C represents user-configured applications and their JA3 Hashes. JA3 and JA3S are TLS fingerprinting methods. JA3 fingerprints the way that a client application communicates over TLS and JA3S fingerprints the server response. Combined, they essentially create a fingerprint of the cryptographic negotiation between the client and server.

Summary section 406 provides a summary regarding the information displayed in graphs 408-414. For example, the total traffic (e.g., in megabytes), the number of unique applications that are being run, the number of countries from which traffic is flowing to/from, and the like. Summary section 406 may include a dropdown that enables a user to select how traffic is to be viewed (e.g., bytes, traffic forwarded by application, traffic by risk severity, traffic by Layer 7 protocol used by applications, traffic by Layer 7 category), etc.).

Graphs 408-414 display information regarding various parameters of the underlying topology. By way of example, graph 408 displays data regarding traffic tied to various applications in use (e.g., Google, Apple iCloud, Sharepoint, etc.). Using graph 408, a user may identify abnormal application usage. Graph 410 displays data regarding traffic associated with various Layer 7 protocols (e.g., HTTP, HTTPS, DNS, BitTorrent, etc.). Using graph 410, a user may identify abnormal Layer 7 activity on a protocol level. Graph 412 displays data regarding risk. Risk is determined from pre-defined hashing on a packet level (i.e., certain hash values are given certain levels of risk ranging from unknown to severe). Using graph 412, the user can assess the overall risk level and take steps to mitigate the risk if necessary. Graph 414 displays data regarding traffic associated with Layer 7 by category (e.g., web, application, database).

FIG. 4B illustrates a table 416 of dashboard 400 that displays information associated with a fingerprinting (i.e., JA3) dictionary. The JA3 dictionary allows the user to build custom definitions for applications so that the system will recognize the application in the future. Each entry in the JA3 dictionary includes a number of parameters regarding the application, and may include, for example, a timestamp indication when the application was used, a gateway associated with the application, the JA3 fingerprint or hash associated with the application, the Layer 7 protocol associated with the application, the Layer 7 Fully Qualified Domain Name associated with the application, the Layer 7 Risk associated with the application, and a Layer 7 latency associated with the application.

FIG. 4C illustrates a table 418 of dashboard 400 that demonstrates the ability to override a JA3 hash to specify an application other than a previously known application. This ability gives the user greater customization of the data shown in dashboard 400.

FIG. 4D illustrates a table 420 of dashboard 400 that demonstrates the ability to assign multiple JA3 hash values to one application. This is useful when different hash values are associated with different instances of what is really the same application. The ability to assign multiple JA3 hash values to one application simplifies and cleans up the data shown in, for example, FIG. 4A as redundant instances of the application do not appear in the results being displayed.

FIG. 4E illustrates in more detail the filter 422 of header section 404 of FIG. 4A. Filter feature allows a user to build a Boolean search based on a variety of parameters. The parameters that may be used to filter include byte size, destination address, TCP flag label, flow locality, direction, CSP tags, bytes, host gateway, destination gateway, source gateway, source IP, source country, destination IP, destination country, traffic type (private vs public), direction of the traffic, timestamps, etc. The filter feature is most helpful for troubleshooting an incident. For example: 1) if an application is not receiving any hits/traffic, the user can filter by destination gateway (behind which the application VM is present) and see if that GW has any flows during the time interval the issue happened; 2) if a gateway is down or not based on the amount of traffic forward by the gateway; 3) if a threat is discovered, identify the source of the threat (IP filters); if anomalous traffic is discovered on a VPC, flowIQ filters like gateway, bytes, IPs can help troubleshoot how much traffic is going through the gateway during the time interval at which anomaly happened; and if a particular port is accidentally open to the world by checking for traffic on the port.

FIGS. 5A-5C illustrate GUI screens displaying portions of a dashboard topology system visualization platform, with each portion configured to illustrate information obtained or determined by the topology system. The interface screens of FIGS. 5A-5C may be referred to as a dashboard 500 that includes several display portions that illustrate various attributes pertaining to a network that is deployed across one or more cloud providers, and notably across multiple cloud providers.

Dashboard 500 is configured to display various parameters that describe disk usage. Referring to FIG. 5A, dashboard 500 illustrates a menu 502 (similar to menu 402), a header section 504, a disk usage and projection section 506, a disk table 508, a Flow IQ section 510, and a performance section 512. Header section 504 provides an estimate of the disk runway (i.e., the amount of time until disk space will run out based upon current disk usage trends). As illustrated in FIG. 5A, the current estimate for disk runway is 58 days. Dashboard 500 allows a user to modify disk usage parameters to manage the disk runway period.

Disk usage and projection section 506 includes a dynamically generated graph 506(1) that displays past disk usage 506(2), projected disk usage 506(3), and full disk usage 506(4). Graph 506(1) breaks down disk usage into multiple categories, including Flow IQ, performance, and other. In various aspects, additional categories can be tracked if desired. Each category of disk usage may be color coded to visually highlight each category.

Disk table 508 lists the available storage disks and provides information regarding the disks, including address/directory, disk size, used disk space, available disk space, and where the disk is mounted.

Flow IQ section 510 provides information regarding disk usage by Flow IQ and allows the user to specify how much Flow IQ data to back up. For example, FIG. 5A illustrates that, using the current configuration, Flow IQ data is using 30.5 GB of disk space via 256 records. The average additional storage per day of Flow IQ data is 5.12 GB. The user may adjust the storage of Flow IQ data by manipulating a slider 510(1). Slider 510(1) allows the user to specify how many days of data to back up. It will be appreciated that slider 510(1) could be any of a variety of user inputs to select the number of days to back up (e.g., drop down, text field, radio buttons, etc.). FIG. 5B, discussed below, illustrates a change made to slider 510(1).

Performance section 512 is similar to Flow IQ section 510, but instead relates to the storage of performance data. Performance section 512 illustrates that, using the current configuration, performance data is using 9.5 GB of disk space via 20.1 million records. The average additional storage per day of performance data is 80.61 MB. The user may adjust the storage of performance data by manipulating a slider 512(1). It will be appreciated that slider 512(1) could be any of a variety of user inputs to select the number of days to back up (e.g., drop down, text field, radio buttons, etc.). Slider 512(1) allows the user to specify how many days of data to back up. FIG. 5B, discussed below, illustrates a change made to slider 512(1).

FIG. 5B illustrates dashboard 500 after changes have been made to sliders 510(1) and 512(1). As shown in FIG. 5A, the estimated disk runway is 58 days. By manipulating sliders 510(1) and 512(1) to the values shown in FIG. 5B, the estimated disk runway (shown in 504 of FIG. 5B) was extended to be over one year. FIG. 5B also illustrates that graph 506(1) has dynamically changed relative to graph 506(1) of FIG. 5A. In particular, the projected disk usage 506(3) has changed due to the changes made to sliders 510(1) and 512(1), while the past disk usage 506(2) remains the same in FIGS. 5A and 5B and full disk usage 506(4) is no longer a part of graph 506(1).

FIG. 5C illustrates a manage data section 514 associated with dashboard 500. Manage data section 514 allows a user to specifically select data for deletion to further manage disk usage. For example, manage data section 514 allows a user to target records for deletion based upon time period (e.g., delete records between a start date/time and an end date/time) or based upon record number (e.g., delete the earliest 1,000 records, delete the last 500 records, etc.). Manage data section 514 provides the user with an additional method to extend and manage the estimated disk runway.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A distributed cloud computing system comprising:
a controller configured to (i) deploy and manage a first gateway in a first cloud computing network and a second gateway in a second cloud computing network, and (ii) manage a plurality of constructs; and
logic, stored on non-transitory, computer-readable medium, that, upon execution by one or more processors, causes performance of operations including:
receiving, from each of the first gateway and the second gateway, network data,
generating an expected network traffic based upon the network data,
generating a visualization illustrating an anomaly that deviates from the expected network traffic, and
causing rendering of the visualization on a display screen of a network device.

2. The distributed cloud computing system of claim 1, wherein the visualization comprises a graph displaying actual network traffic overlayed on top of the expected network traffic.

3. The distributed cloud computing system of claim 2, wherein the expected network traffic is divided into a plurality of thresholds of expected network traffic.

4. The distributed cloud computing system of claim 3, wherein the plurality of thresholds includes:
a first threshold that illustrates a tolerance range of the expected network traffic; and
a second threshold that illustrates values of network traffic that exceed the first threshold.

5. The distributed cloud computing system of claim 4, wherein, when the network traffic is within the first threshold, the visualization does not include a visual indication of the anomaly and, when the network traffic exceeds the second threshold, the visualization comprises a visual indication of the anomaly.

6. The distributed cloud computing system of claim 2, wherein the visualization comprises a secondary graph displaying parameters describing the network data.

7. The distributed cloud computing system of claim 6, wherein the parameters describing network data are one or more of TCP ports and IP addresses.

8. The distributed cloud computing system of claim 1, wherein the visualization includes a user input that allows a user to characterize the anomaly as not an anomaly.

9. The distributed cloud computing system of claim 8, wherein, responsive to an indication that the anomaly is not an anomaly, using the data associated with the anomaly as part of the network data upon which the expected network traffic is generated.

10. The distributed cloud computing system of claim 1, wherein the visualization includes a graph of disk usage and projected disk runway.

11. The distributed cloud computing system of claim 10, wherein the visualization includes a user input configured to select an amount of time for which data is to be backed up.

12. The distributed cloud computer system of claim 11, wherein the graph of disk usage dynamically changes in response to manipulations of the user input.

13. A non-transitory computer-readable medium having stored thereon logic that, when executed by one or more processors, causes operations including:
receiving, from a controller, network data from a first gateway and a second gateway,
generating an expected network traffic based upon the network data,
generating a visualization illustrating an anomaly that deviates from the expected network traffic, and
causing rendering of the visualization on a display screen of a network device.

14. The non-transitory computer-readable medium of claim 13, wherein the visualization comprises a graph displaying actual network traffic overlayed on top of the expected network traffic.

15. The non-transitory computer-readable medium of claim 14, wherein the expected network traffic is divided into a plurality of thresholds of expected network traffic.

16. The non-transitory computer-readable medium of claim 15, wherein the plurality of thresholds includes:
a first threshold that illustrates a tolerance range of the expected network traffic; and
a second threshold that illustrates values of network traffic that exceed the first threshold.

17. The non-transitory computer-readable medium of claim 16, wherein, when the network traffic is within the first threshold, the visualization does not include a visual indication of the anomaly and, when the network traffic exceeds the second threshold, the visualization comprises a visual indication of the anomaly.

18. The non-transitory computer-readable medium of claim 14, wherein the visualization comprises a secondary graph displaying parameters describing the network data.

19. The non-transitory computer-readable medium of claim 18, wherein the parameters describing network data are one or more of TCP ports and IP addresses.

20. The non-transitory computer-readable medium of claim 13, wherein the visualization includes a user input that allows a user to characterize the anomaly as not an anomaly.

21. The non-transitory computer-readable medium of claim 20, wherein, responsive to an indication that the anomaly is not an anomaly, using the data associated with the anomaly as part of the network data upon which the expected network traffic is generated.

22. The non-transitory computer-readable medium of claim 13, wherein the visualization includes a graph of disk usage and projected disk runway.

23. The non-transitory computer-readable medium of claim 22, wherein the visualization includes a user input configured to select an amount of time for which data is to be backed up.

24. The non-transitory computer-readable medium of claim 22, wherein the graph of disk usage dynamically changes in response to manipulations of the user input.

25. A computerized method comprising:
receiving, from a controller, network data from a first gateway and a second gateway,
generating an expected network traffic based upon the network data,
generating a visualization illustrating an anomaly that deviates from the expected network traffic, and
causing rendering of the visualization on a display screen of a network device.

26. The computerized method of claim 25, wherein the visualization comprises a graph displaying actual network traffic overlayed on top of the expected network traffic.

27. The computerized method of claim 26, wherein the expected network traffic is divided into a plurality of thresholds of expected network traffic.

28. The computerized method of claim 27, wherein the plurality of thresholds includes:
a first threshold that illustrates a tolerance range of the expected network traffic; and
a second threshold that illustrates values of network traffic that exceed the first threshold.

29. The computerized method of claim 28, wherein, when the network traffic is within the first threshold, the visualization does not include a visual indication of the anomaly and, when the network traffic exceeds the second threshold, the visualization comprises a visual indication of the anomaly.

30. The computerized method of claim 26, wherein the visualization comprises a secondary graph displaying parameters describing the network data.

31. The computerized method of claim 30, wherein the parameters describing network data are one or more of TCP ports and IP addresses.

32. The computerized method of claim 25, wherein the visualization includes a user input that allows a user to characterize the anomaly as not an anomaly.

33. The computerized method of claim 32, wherein, responsive to an indication that the anomaly is not an anomaly, using the data associated with the anomaly as part of the network data upon which the expected network traffic is generated.

34. The computerized method of claim 25, wherein the visualization includes a graph of disk usage and projected disk runway.

35. The computerized method of claim 34, wherein the visualization includes a user input configured to select an amount of time for which data is to be backed up.

36. The computerized method of claim 34, wherein the graph of disk usage dynamically changes in response to manipulations of the user input.
